(19) United States
(12) Patent Application Publication
(10) Pub. No.: US 2026/0299125 A1
(43) Pub. Date: Oct. 1, 2026

(54) SONAR-PARAMETERIZED, CONTINUOUS, LOCALIZED BASIS FUNCTION SPLATTING FOR SONAR IMAGE SYNTHESIS

(71) Applicant: The Regents of the University of Michigan, Ann Arbor, MI (US)

(72) Inventors: Katherine A. Skinner, Ann Arbor, MI (US); Advaith Sethuraman, Ann Arbor, MI (US); Nibarkavi N. Amutha, Ann Arbor, MI (US); Jack Wischmeyer, Ann Arbor, MI (US); Pou-Chun Kung, Ann Arbor, MI (US); Max Rucker, Boyds, MD (US); Onur Bagoren, Ann Arbor, MI (US)

(21) Appl. No.: 19/633,744

(22) Filed: Mar. 30, 2026

Related U.S. Application Data
(60) Provisional application No. 63/780,293, filed on Mar. 29, 2025.

(51) Int. Cl. G01S 15/89; G06T 15/08

(52) U.S. Cl. CPC G01S 15/89; G06T 15/08

(57) ABSTRACT

A system and method for: generating a sonar image for a given pose through splatting continuous, localized radial basis functions; generating an azimuth-streaked sonar image representing a scene; and/or de-streaking a sonar image. The system is configured to perform one or more of the methods. The method of generating a sonar image for a given pose through splatting continuous, localized radial basis functions includes: obtaining a set of multi-dimensional continuous localized basis functions used to represent a scene; and generating a sonar image, such as a range-azimuth sonar image, of the scene for a given pose based on the set of multi-dimensional continuous localized basis functions.

### STATEMENT REGARDING FEDERALLY SPONSORED RESEARCH/DEVELOPMENT

This invention was made with government support under 2337774 awarded by the National Science Foundation. The government has certain rights in the invention.

### TECHNICAL FIELD

This disclosure relates to imaging sonar and, more particularly, generation of sonar images using rasterization and synthesis of scenes (including underwater scenes) represented as a set of continuous, localized basis functions.

### BACKGROUND

Acoustic sensors, such as imaging sonar, are commonly used for infrastructure inspection, large-area mapping, and target detection in underwater environments. Unlike optical sensors, which are severely range-limited due to water column effects on light propagation, acoustic sensors can capture data at long ranges to provide critical information about subsea environments. Although sonar exhibits many desirable qualities such as longer range, invariance to lighting conditions, and the ability to discern material properties, there exist acoustic phenomena, including elevation ambiguity, azimuth streaking, and multi-path reflections, which make sonar interpretation difficult for operators and computer vision algorithms alike. Furthermore, the severe lack of large, public datasets for sonar slows progress in traditional computer vision tasks like object detection, segmentation, and reconstruction.

Recently, neural radiance fields (NeRFs) have demonstrated the potential for high-fidelity data synthesis and denoising of optical imagery. The benefits of neural rendering have been recognized by the underwater perception community, with prior work exploring neural rendering for 3D object reconstruction using underwater cameras and sonar data. While these innovations are promising, training and processing NeRFs is extremely costly and time-consuming, rendering deployment of them in real-time or on resource-constrained devices difficult. More recently, 3D Gaussian splatting (3DGS) was developed as a faster alternative to NeRF. 3DGS utilizes sparse points in the form of 3D Gaussians to represent the scene. This allows preservation of properties of continuous, volumetric, localized radiance fields while lowering computational costs.

Gaussian splatting has been leveraged for underwater imagery through use of a framework named “ZSplat” [Ziyuan Qu, Omkar Vengurlekar, Mohamad Qadri, Kevin Zhang, Michael Kaess, Christopher Metzler, Suren Jayasuriya, and Adithya Pediredla. Z-splat: Z-axis gaussian splatting for camera-sonar fusion, 2024; referred to hereinafter as “ZSplat”]. ZSplat proposes a Gaussian splatting framework for RGB-sonar fusion, which leverages the fusion of sonar data to improve the rendering of RGB (red, green, blue) images and does not enable high-fidelity data synthesis for sonar imagery or provide evaluation for the quality of rendered sonar images. Thus, there is a clear gap in the literature for a framework capable of efficient and effective sonar image synthesis.

### SUMMARY

In accordance with a first aspect of the invention, there is provided a method of generating a sonar image for a given pose through splatting continuous, localized radial basis functions. The method includes: obtaining a set of multi-dimensional continuous localized basis functions used to acoustically represent a scene; and generating a range-azimuth sonar image of the scene for a given pose based on the set of multi-dimensional continuous localized basis functions.

According to various embodiments, the method of the first aspect of the invention may further be characterized by any of those features discussed in connection with the second, third, and/or fourth aspects of the invention and/or or any technically-feasible combination of some or all of these features:
the range-azimuth sonar image of the scene for the given pose is generated through splatting each multi-dimensional continuous localized basis function of the set of multi-dimensional continuous localized basis functions;
each multi-dimensional continuous localized basis function is a three-dimensional (3D) continuous localized basis function;
each multi-dimensional continuous localized basis function is a 3D Gaussian;
each multi-dimensional continuous localized basis function of the set of multi-dimensional continuous localized basis functions used to represent the scene is parameterized with one or more acoustic parameters; and/or
the one or more acoustic parameters includes acoustic reflectivity and/or azimuth streak probability.

In accordance with a second aspect of the invention, there is provided a method of generating an azimuth-streaked sonar image representing a scene. The method includes: obtaining a set of multi-dimensional continuous localized basis functions used to represent a scene; generating an initial sonar image based on rasterizing the scene into for a given pose; determining an azimuth streak probability image based on the set of multi-dimensional continuous localized basis functions for the given pose; determining azimuth streak receiver gain data based on the azimuth streak probability image; and generating an azimuth-streaked sonar image for the given pose based on the azimuth streak receiver gain data and the initial sonar image.

According to various embodiments, the method of the second aspect of the invention may further be characterized by any of those features discussed in connection with the first, third, and/or fourth aspects of the invention and/or any one of the following features or any technically-feasible combination of some or all of these features:
the azimuth-streaked sonar image is a range-azimuth sonar image that is generated through splatting each multi-dimensional continuous localized basis function of the set of multi-dimensional continuous localized basis functions;
each multi-dimensional continuous localized basis function is a three-dimensional (3D) continuous localized basis function;
each multi-dimensional continuous localized basis function is a 3D anisotropic Gaussian;
each multi-dimensional continuous localized basis function of the set of multi-dimensional continuous localized basis functions used to represent the scene is parameterized with one or more acoustic parameters;
the one or more acoustic parameters includes azimuth streak probability;
the one or more acoustic parameters is a plurality of acoustic parameters including the azimuth streak probability and at least one other acoustic parameter;
the at least one other acoustic parameter includes acoustic reflectivity;
the rasterizing used for generating the initial sonar image is performed in accordance with an acoustic image formation model that includes at least one acoustic parameter;
the at least one acoustic parameter includes a first acoustic parameter that is different than the one or more acoustic parameters such that a different set of acoustic parameters is used for parameterizing the set of multi-dimensional continuous localized basis functions than those used in the acoustic image formation model for rasterization;
the method comprises: performing machine learning for the machine learning model based on the azimuth-streaked sonar image for the given pose and a ground truth sonar image for the given pose;
a plurality of azimuth-streaked sonar images are generated and each of the plurality of azimuth-streaked sonar images is paired with a corresponding ground truth sonar image based on correspondence in the given pose;
the machine learning is performed for the machine learning model using a training process that includes, for each of the azimuth-streaked sonar images, updating one or more parameter values of the machine learning model based on a loss calculated between the azimuth-streaked sonar image and the corresponding ground truth sonar image.

In accordance with a third aspect of the invention, there is provided a method of generating a sonar image for a given pose through splatting continuous, localized radial basis functions. The method includes: obtaining a set of multi-dimensional continuous localized basis functions used to represent a scene, wherein each multi-dimensional continuous localized basis functions of the set of multi-dimensional continuous localized basis functions is parameterized with a plurality of acoustic parameters including an acoustic target parameter; generating an initial sonar image of the scene for a given pose based on splatting at least one acoustic parameter other than the acoustic target parameter according to the given pose; generating an acoustic target parameterized image for the given pose based on splatting the acoustic target parameter of the set of multi-dimensional continuous localized basis functions according to the given pose; and generating a sonar image for the given pose based on the initial sonar image for the given pose and the acoustic target parameterized image for the given pose.

According to various embodiments, the method of the third aspect of the invention may further be characterized by any of those features discussed in connection with the first, second, and/or fourth aspects of the invention.

In accordance with a fourth aspect of the invention, there is provided a method of de-streaking a sonar image. The method includes: obtaining a set of multi-dimensional continuous localized basis functions used to represent a scene, wherein each multi-dimensional continuous localized basis functions of the set of multi-dimensional continuous localized basis functions is parameterized with at least one acoustic parameter; obtaining training data having at least one training data entry comprised of an azimuth-streaked sonar image for a given pose and a ground truth sonar image for the given pose, learning a set of azimuth-streak probability parameters for the using machine learning performed based on the training data; obtaining a subject sonar image; determining azimuth streak receiver gain data for the subject sonar image based on the learned set of azimuth-streak probability parameters; and generating an azimuth-destreaked image based on the azimuth streak receiver gain data and the learned set of azimuth-streak probability parameters.

According to various embodiments, the method of the fourth aspect of the invention may further be characterized by any of those features discussed in connection with the first, second, and/or third aspects of the invention and/or the at least one acoustic parameter is azimuth streak probability.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram depicting a computer-based communications system having a sonar image synthesis system, an interconnected computer-based communications network, and a client computer system with a client computer that is usable/operable by a human user, according to one embodiment;

FIG. 2 is a flowchart illustrating a method of generating a sonar image for a given pose through splatting continuous, localized basis functions (e.g., anisotropic basis functions such as anisotropic Gaussians) representing a scene in accordance with an acoustic image formation model, according to one embodiment;

FIG. 3 is a flowchart illustrating a method of generating an azimuth-streaked sonar image representing a scene, such as an underwater scene, as taken from a given pose, according to one embodiment; and

FIG. 4 depicts a block diagram of a processing framework or method for optimizing azimuth streaking probability of each Gaussian, according to one embodiment.

### DETAILED DESCRIPTION

The system and method described herein enables generation of sonar images through adapting an optical Gaussian splatting technique for use in rasterization of a set of multi-dimensional (MD) (generally, for example, three-dimensional (3D)) continuous basis functions into an acoustic or sonar image. The sonar image is formed through rasterization of the set of MD Gaussians using a sonar-adapted rasterization equation in which one or more acoustic properties (e.g., acoustic reflectivity, transmittance) are parameterized or otherwise integrated so as to respect pose-dependent acoustic properties and effects when synthesizing sonar images for novel poses. This and other inventive aspects provided herein will be made apparent in light of the following discussion.

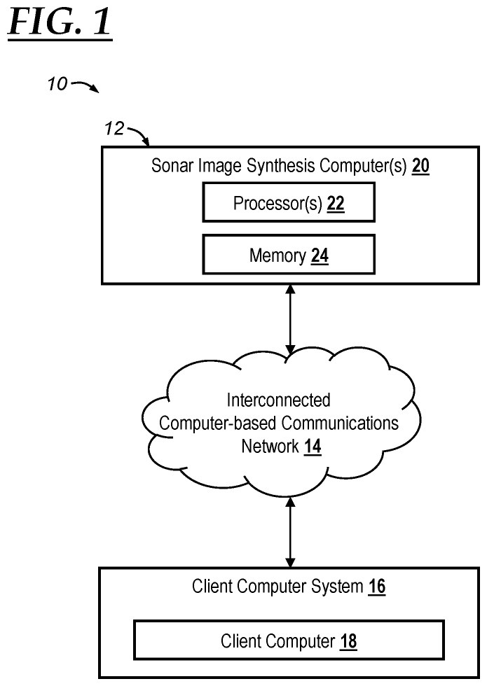

With reference to FIG. 1, there is shown a computer-based communications system 10 having a sonar image synthesis system 12, an interconnected computer-based communications network 14, and a client computer system 16 with a client computer 18 that is usable/operable by a human user or simply “user”. The computer-based communications system 10 is used for enabling electronic data communications between computers such as the client computer 18 and one or more computers implementing the sonar image synthesis system 12.

The sonar image synthesis system 12 is a specialized computer system that is specialized as a result of being specifically configured to perform sonar image synthesis. At least in embodiments, this sonar image synthesis that is implemented by the sonar image synthesis system 12 pursuant to the method discussed herein. Accordingly, in embodiments, the sonar image system 12 is configured to perform sonar image synthesis through configuring, modifying, or otherwise adapting a general purpose computer (or a plurality of general purpose computers) to perform a particular function through provisioning of predetermined computer instructions, which are referred to as “sonar image synthesis computer instructions” generally and these adapted computers referred to as sonar image synthesis computer(s) 20. The sonar image synthesis computer instructions for the system 12 are composed in accordance with the method discussed herein, at least in embodiments.

The sonar image synthesis computer(s) 20 are each a computer comprised of hardware, namely at least one processor 22 and memory 24, as well as software or other computer code or instructions (collectively referred to herein as “computer instructions”) that is executed by the hardware. Accordingly, computer instructions are stored in the memory 24 of the system 12, and these computer instructions are made available to the at least one processor 22 of the system 12, which then executes the computer instructions so as to perform the method discussed below.

The sonar image synthesis computer(s) 20 include one or more local and/or remote (e.g., cloud-based) computers or controllers, according to embodiments. The at least one processor 22 refers to one or more electronic processors. Any one or more of these processors 22 or other processors discussed herein may be implemented as any suitable electronic hardware that is capable of processing computer instructions and may be selected based on the application in which it is to be used. Examples of types of processors that may be used include central processing units (CPUs), graphics processing units (GPUs), field-programmable gate arrays (FPGAs), application specific integrated circuits (ASICs), microprocessors, microcontrollers, etc.

The memory 24 refers to one or more non-transitory, computer-readable memory devices (or memories), and any of these memories or other memory discussed herein may be implemented as any suitable type of memory that is capable of storing data or information in a non-volatile manner and in an electronic form so that the stored data or information is consumable by the processor. The memory 24 or any of the other memory taught herein may be any of a variety of different electronic memory types and may be selected based on the application in which it is to be used. Examples of types of memory that may be used include magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc. It will be appreciated that the computers may include other memory, such as volatile RAM that is used by the processor, and/or multiple processors.

The memory 24 serves as a local data store for storing the computer instructions, but may also be used for storing various data obtained or generated by the system 12. A “data store” or “electronic data store” refers to any data storage platform, such as cloud storage services like Amazon S3™ or Google Drive™, relational databases like MySQL™ or PostgreSQL™, and NoSQL databases like MongoDB™ or Cassandra™, that is designed for storing data in a manner accessible by electronic processing systems. This includes any repository that allows for the organization, management, and retrieval of data through digital means, enabling efficient data handling, analysis, and processing by computers and other electronic devices. This electronic data store could take the form of a cloud database, such as Amazon's DynamoDB™, which offers seamless scalability and performance. Alternatively, for structured data and frequent queries, a relational database like MySQL™ or PostgreSQL™ could be employed. If the data is unstructured or semi-structured and comes in large volumes, NoSQL databases such as MongoDB™ or Apache Cassandra™ might be more suitable. For data that is time-series in nature, time-series databases like InfluxDB™ or TimescaleDB™ could provide efficient storage and query capabilities. For large-scale data analysis, data warehousing solutions such as Google BigQuery™, Amazon Redshift™, or Snowflake™ can be used. In cases where fast data access is paramount, in-memory databases like Redis™ or Memcached™ could be employed. Lastly, for storing large volumes of raw data, distributed file systems like Hadoop HDFS™ or cloud-based solutions like Amazon S3™ could be used. The choice of data store would ultimately depend on the specific requirements of the system handling the data. The system 12 may be implemented using a variety of different processing techniques, including use of cloud computing frameworks and services, such as those offering real-time data streaming and processing, such as Amazon Web Services (AWS) Kinesis™, for example. In other embodiments, local computers or processing machines may be used for the hardware.

The client computer system 16 is used by a user for receiving information from the sonar image synthesis system 12, such as output or sonar images generated thereat. The client computer 18 is a computer that has or is operably coupled with a human machine interface (HMI), such as a display screen or monitor or audio speaker. For example, the client computer 18 may be a desktop computer with Windows™ or Linux™ operating system and being coupled to a computer monitor so that information at the client computer 18 may be presented to a user. Of course, other such computers may be used as the client computer 18, according to embodiments.

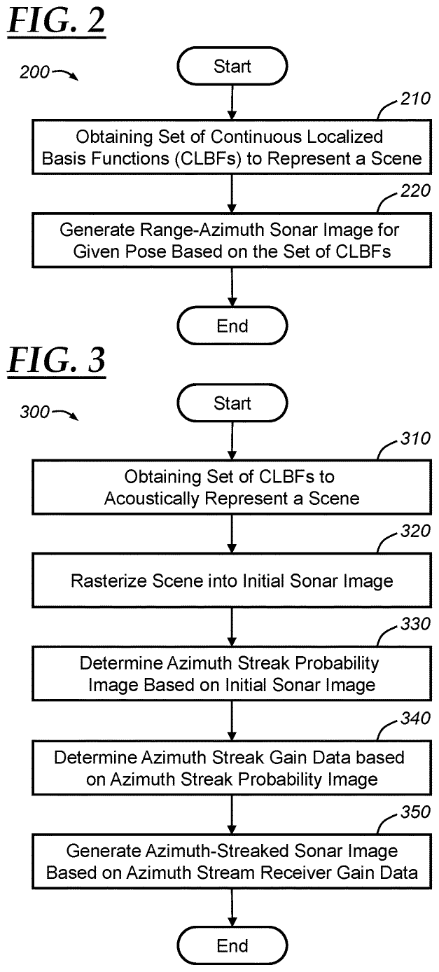

With reference to FIG. 2, there is shown a method 200 of generating a sonar image for a given pose through splatting continuous, localized basis functions (e.g., anisotropic basis functions such as anisotropic Gaussians) representing a scene in accordance with an acoustic image formation model, which may be referred to also (at least in the present embodiment) as a range-azimuth splatting model. The method 200 provides an example of a method of generating a sonar image for a given pose through performing Gaussian splatting using an acoustic image formation model. The method 200 is used for generating a sonar image for a pose, and this sonar image resulting may be used as the unsaturated image in the method 300, which is discussed below.

The method 200 begins with step 200, wherein a set of multi-dimensional (MD) (particularly, three-dimensional (3D) in the present embodiment) continuous localized basis functions (e.g., Gaussians) used to represent a scene is obtained. The initialism “CLBF” stands for continuous localized basis function, as used herein; likewise, “CLABF” stands for continuous localized anisotropic basis function, as used herein. In embodiments, the scene is an underwater scene that is represented by a set of 3D CLBFs, such as a set of 3D Gaussians. In the present embodiment, the MD Gaussians are 3D Gaussians and are used for generating a 2D (or “MD-1”) image.

Gaussians or other like continuous functions are used to represent a scene, providing for reconstruction of images of the scene using smoothly varying mathematical functions that model the intensity and spread of reflected signals. These functions serve as the fundamental building blocks for representing how waves, whether light or sound, interact with surfaces in a scene. Instead of relying on discrete point-based representations or mesh-based geometry, this approach distributes the contribution of each function smoothly across space, ensuring a continuous and visually coherent reconstruction of the environment. Splatting is used to project and blend these functions onto an image plane corresponding to a specific viewpoint, generating a smooth, interpretable sonar image for the observer at that pose.

A Gaussian is a specific type of continuous basis function characterized by a smooth, bell-shaped distribution that defines how values fall off from a central point. It will be appreciated that the Gaussians referred to herein may each be anisotropic in that different variances or correlations exist along different directions/axes. In a multivariate setting, a Multivariate Normal Distribution describes a Gaussian in multiple (typically three) dimensions, defining not only its center but also its spread and orientation through a covariance matrix. Gaussians are useful in imaging and rendering applications because they provide a mathematically convenient and computationally efficient way to model localized influences with smooth transitions. Each Gaussian represents a region of the scene, with its intensity and spread encoding information about the strength and dispersion of reflected signals. When used in splatting, Gaussians allow for the seamless blending of contributions from multiple scene elements, which operates to avoid sharp edges or artifacts that can arise from simpler point-based representations.

A Gaussian is an example of a continuous, localized basis function (CLBF), which is a more general mathematical concept that describes any function that smoothly (in a continuous manner) decreases in influence as the distance from a central point (locality) increases. An anisotropic basis function (ABF) is considered to be a “non-radial” basis function due to its variances observed along different axes as they extend from a central point. For example, an anisotropic Gaussian is an example of an ABF as is a multiquadric, inverse multiquadric, polyharmonic splines, and thin plate splines, as some examples that could be used in place of Gaussians, at least in an embodiment. Gaussians are a specific type of continuous localized basis function, but other functions, such as multiquadrics or thin-plate splines, also fall under this category. Considerable properties of these CLBFs are localization and smooth decay, meaning they predominantly affect a nearby region while tapering off at a distance. These functions act as weighted influence zones where each function represents an estimate of how much signal or energy is reflected from different parts of the environment, with their continuous nature ensuring that the final reconstructed image does not suffer from abrupt discontinuities, preserving realistic depth and intensity variations.

The parametrization of Gaussians used in prior methods in connection with optical-based rendering does not include any acoustic-specific variables or parameters. An acoustic image formation model is incorporated and used for splatting in order to adapt optical-based Gaussian splatting to sonar image synthesis. Imaging sonar sensors (also referred to as “imaging sonars”) emit acoustic energy from a transmitter then listen for returns on the receiver. Imaging sonar is a time-of-flight (TOF) sensor that can provide the echo intensities at a given range and azimuth bin (“range-azimuth bin”). Elevation ambiguity results from such conventional range-azimuth sonar image techniques, contributing to difficulties in distinguishing the elevation angle of a return. This elevation angle ambiguity makes direct use of imaging sonar difficult for 3D reconstruction and triangulation tasks.

Thus, according to embodiments, each of the CLBFs (e.g., 3D Gaussians) is parameterized with one or more acoustic parameters. Each acoustic parameter is a parameter representing a presence or extent of an acoustic attribute, such as, for example, acoustic reflectivity vᵢ and azimuth streak probability pᵢ, as discussed below.

In embodiments, the scene is represented with a set of 3D Gaussians

$$𝒢 = {\{ {G}_{i} \}}_{i = 1}^{N} .$$

Gaussians are parametrized with a mean μᵢ∈ [symbol] , scale sᵢ∈ [symbol] , orientation qᵢ∈ [symbol] , opacity oᵢ∈ [symbol] , acoustic reflectivity vᵢ∈ [symbol] , and azimuth streak probability pᵢ∈ [symbol] :

$${G}_{i} = \{ {μ}_{i} , {s}_{i} , {q}_{i} , {o}_{i} , {v}_{i} , {p}_{i} \}$$

where the covariance matrix is constructed from the rotation (qᵢ) and scaling (sᵢ) of each Gaussian, each of which is converted to a rotation matrix, Rᵢ∈ [symbol] , and scaling matrix Sᵢ∈

[symbol]

$${Σ}_{i} = {R}_{i} {S}_{i} {S}_{i}^{T} {R}_{i}^{T}$$

In optical Gaussian splatting, the Gaussians are parameterized with color information. The method 200 continues to step 220.

In step 220, a range-azimuth sonar image of the scene for a given pose is generated based on the set of MD continuous localized basis functions (CLBFs) and, more particularly, by splatting each of the set of MD continuous localized basis functions according to a given pose. The given pose, when used in connection with an image of a scene, is used for indicating the position and orientation of a point of view of the image relative to the scene. For example, the given pose of the range-azimuth sonar image to be generated for the scene represented by the set of MD continuous localized basis functions is indicative of a relative position and orientation of the point of view of the range-azimuth sonar image to be generated and the scene. As discussed above, in embodiments, the set of MD CLBFs is the set of 3D Gaussians discussed above that have been parameterized with one or more acoustic parameters, such as, for example, acoustic reflectivity vᵢ and azimuth streak probability pᵢ.

A sonar image is a representation of an environment based on sound wave reflections rather than captured light, as in a conventional camera image. Unlike optical images, which are formed by capturing and processing light intensities across a sensor array, sonar images are constructed by measuring the time delay, intensity, and frequency shift of acoustic signals bouncing off surfaces. A sonar image is generally represented as an azimuth-range image in that it is comprised of a set of bins, each for a particular range and azimuth of the scene as taken from a pose for the sonar image (where the observer is situated). The primary axes of an azimuth-range sonar image correspond to azimuth (horizontal angle) and range (distance to the reflecting object), rather than the pixel-based spatial representation of a standard camera image. Because sonar relies on the propagation of sound waves, its resolution and clarity are affected by factors such as wavelength, signal frequency, medium properties, and interference, leading to unique distortions and artifacts compared to optical imaging, especially (at least according to some embodiments) in terms of elevation as discussed above.

In the context of the present method 200 and acoustic-parameterized technology provided herein, splatting refers to a process that transforms a set of continuous localized basis functions (e.g., Gaussians) into a sonar image for a given pose by projecting and blending their influence onto a two-dimensional (2D) image plane. Each Gaussian (or continuous localized BF), representing a localized region of the scene, is mapped onto the viewpoint of the observer (corresponding to the pose for the image to be generated) in a manner such that its contribution over multiple pixels is had in accordance with its size, shape, and intensity. This process helps to ensure that overlapping contributions from different functions merge seamlessly so as to create a coherent image that represents the sonar reflections as they would be perceived from that specific pose. By using splatting, the sonar image becomes a smooth, continuous representation of the scene's structure and reflectivity, effectively capturing the complex wave interactions in a visually meaningful way.

Provided below is an exemplary embodiment for performing acoustic 3D Gaussian splatting in order to render sonar images for a given pose. In such exemplary embodiment, to render sonar images, the means and covariances of the Gaussians are transformed into spherical coordinates. Here, for a given 3D Gaussian in the sensor local frame in Cartesian coordinates, Gₖ={μₖ= [symbol] xₖ, yₖ, zₖ [symbol] , Σₖ}, the transformation to spherical coordinates is as follows:

$${μ}_{s} = [ \begin{matrix}{r}_{k} \\ {θ}_{k} \\ {ϕ}_{k}\end{matrix} ] = [ \begin{matrix}\begin{matrix}‖ {μ}_{k} ‖ \\ arctan ( {y}_{k} , {x}_{k} )\end{matrix} \\ arctan ( {z}_{k} , \sqrt{{x}_{k}^{2} + {z}_{k}^{2}} )\end{matrix} ]$$

The covariance Σₖ is transformed by using a first-order linearization of the coordinate transformation, which the Jacobian describes:

$${J}_{s} = [ \begin{matrix}\frac{{x}_{k}}{‖ {μ}_{k} ‖} & \frac{{y}_{k}}{‖ {μ}_{k} ‖} & \frac{{z}_{k}}{‖ {μ}_{k} ‖} \\ \frac{- y}{{x}^{2} + {y}^{2}} & \frac{x}{{x}^{2} + {y}^{2}} & 0 \\ \frac{- {x}_{k} \cdot {z}_{k}}{{‖ {μ}_{k} ‖}^{2} \sqrt{{x}^{2} + {y}^{2}}} & \frac{- {y}_{k} \cdot {z}_{k}}{{‖ {μ}_{k} ‖}^{2} \sqrt{{x}^{2} + {y}^{2}}} & \frac{\sqrt{{x}^{2} + {y}^{2}}}{{‖ {μ}_{k} ‖}^{2}}\end{matrix} ]$$

and the covariance matrix becomes:

$${Σ}_{s} = {J}_{s} {Σ}_{k} {J}_{s}^{T}$$

In continuing with the present example, to convert the spherical coordinate mean and covariance into range/azimuth image space, we first specify the intrinsic matrix K of the sonar,

$$K = [ \begin{matrix}\frac{1}{{ϵ}_{r}} & 0 & 0 \\ 0 & \frac{1}{{ϵ}_{a}} & \frac{{N}_{a}}{2} \\ 0 & 0 & 1\end{matrix} ]$$

and then the following transformation is performed:

$${μ}^{′} = K {μ}_{s} , {Σ}^{′} = {J}_{K} W {Σ}_{s} W {J}_{K}^{T}$$

where J_{K} is the Jacobian of K, and W is the sensor's view matrix, similar to the camera splatting formulation.

To find the intensity of acoustic returns at a given range-azimuth bin (rᵢ, θⱼ), we consider [symbol] _{i,j}⊂ [symbol] , the set of Gaussians transformed to range-azimuth image space that overlap with the range-azimuth bin (rᵢ, θⱼ). The rasterization equation to obtain the sonar image for SonarSplat is similar to that of, with a few key differences. SonarSplat's rasterization equation is given by:

$${I}_{U} ( {r}_{l} , {θ}_{j} ) = {\sum }_{{G}_{k} ∈ {𝒢}_{i , j}} {v}_{k} {o}_{k} {T}_{k} {G}_{k} ( {r}_{i} , {θ}_{j} )$$

where vₖ∈[0,1] is introduced in the present embodiment as the acoustic reflectance of the Gaussian and Tk as the transmittance from the sensor origin to the Gaussian along the range. The subscript indicates that I_{U} is the unsaturated image—as used herein, “unsaturated”, when used in connection with an image, means that the image does not account for the azimuth streaking that causes saturation across the image. Acoustic reflectance of a set of points depends on material properties and viewing angle, so vₖ uses spherical harmonics to encode view-dependent effects. The method 200 ends.

As discussed below, the method 200 may be used for generating an unsaturated sonar image for use in a method of generating azimuth-streaked sonar image representing a scene, such as an underwater scene, as taken from a given pose, such as that which is described below in connection with FIG. 3 and its method 300.

With reference now to FIG. 3, there is shown a method 300 of generating an azimuth-streaked sonar image representing a scene, such as an underwater scene, as taken from a given pose. The method 300 is performed by the computer-based sonar image synthesis system 12, at least in one embodiment.

The method 300 begins with step 310, wherein a set of multi-dimensional continuous localized basis functions (CLBFs and, more specifically, 3D Gaussians in the exemplary embodiment) that is used to acoustically represent a scene, such as, for example, an underwater scene (e.g., under a lake, ocean), is obtained. As used herein, “acoustically”, when used in connection with characterizing a scene (such as a scene represented by a set of CLBFs), refers to characterizing the scene in a manner that is communicable through sound waves, such as through inclusion of one or more acoustic parameters into each CLBF of the set of CLBFs. An example of acoustically representing the scene is described above in connection with the method 200 where the scene is represented as a set of 3D Gaussians, each parameterized with a mean, co-variance, opacity, acoustic reflectivity, and azimuth streaking probability. The method 300 continues to step 320.

In step 320, the scene is rasterized into an initial sonar image for a given pose. The initial sonar image, at least in embodiments, is an unsaturated sonar image, such as the one generated by step 220 of the method 200. The rasterization is performed in accordance with an acoustic image formation model that includes acoustic parameters, including acoustic reflectance of the Gaussian and transmittance from the sensor origin to the Gaussian along the range as acoustic parameters of each Gaussian. The method 300 continues to step 330.

In step 330, an azimuth streak probability image is determined based on the set of multi-dimensional continuous localized basis functions used to represent the scene. The azimuth streak probability image refers to an image comprised of a plurality of azimuth-range bins, each of which is associated with an azimuth streak probability occurring. Azimuth streaking is a phenomena that is frequently observed in sonar images, and is a form of saturation that occurs when the sonar receiver receives strong returns from incident angles close to parallel at a specific range bin rt. In embodiments, an azimuth streaking model (an example of an a “feature-specific model” as it is specific to azimuth streaking) is used in which all the returns in a range interval are modified if a certain percentage of returns exceeds a given threshold 3. The image with added azimuth streaks (the “azimuth-streaked sonar image”) that is ultimately generated by the method 300 at step 350 is given by:

$$\hat{I} ( {r}_{i} , \cdot ) = 1 - {( 1 - I ( {r}_{i} , \cdot ) )}^{2}$$

where Î (rᵢ, ·) is the streaked image (resulting from step 350), and I(rᵢ,·) is the vector of intensities at range interval rt.

In the present embodiment, an acoustic image formation model is used and then each Gaussian is assigned a probability that it will cause an azimuth streak. During the splatting process, this probability is accumulated as a function of the Gaussian's opacity, mean, and covariance. At least in the present embodiment, the benefit of defining this probability per-Gaussian is that it can be optimized to produce azimuth streaks that are multi-view consistent.

In general, “splatting” refers to projecting a multi-dimensional scene (having # of dimensions N_{MD}) into a lower-dimensioned domain (i.e., a space or domain characterized by less dimensions than the multi-dimensional scene—a domain of no more than N_{D}—1 dimensions) whereby this lower-dimensioned projection (or “splat”) is used for generating a lower-dimensioned (having # of dimensions N_{LD}), posed representation of the multi-dimensional scene. In the present embodiment, the multi-dimensional scene is a three-dimensional (3D) scene (N_{MD}=3) and the lower-dimensioned projections are used to form a two-dimensional (2D) image (N_{LD}=2). More particularly, in the present embodiment, splatting of a 3D Gaussian involves projecting a 3D anisotropic Gaussian onto a 2D image plane. This projection maps a continuous volumetric representation into a screen-space footprint, preserving spatial and radiometric properties such as position, scale, orientation, opacity, and other attributes parameterized as a part of each Gaussian. The resulting splats, often and which may be in the form of 2D elliptical Gaussians, are then blended to reconstruct a smooth, view-dependent rendering of the scene. Furthermore, in the present embodiment, the Gaussians are each parameterized with one or more acoustic parameters, such as, for example, the acoustic azimuth streaking parameter of the present embodiment.

Let pₖ∈[0,1] be the probability that Gaussian k will contribute to an azimuth streaking phenomena. Then, these per-Gaussian probabilities are splatted into a range-azimuth bin to obtain an azimuth streak probability image Pₐ:

$${P}_{a} ( {r}_{i} , {θ}_{j} ) = {\sum }_{{G}_{k} ∈ {𝒢}_{i , j}} {p}_{k} {o}_{k} {T}_{k} {G}_{k} ( {r}_{i} , {θ}_{j} )$$

$${M}_{a} ( {r}_{i} ) = {\sum }_{θ = 0}^{{N}_{a}} {P}_{a} ( {r}_{i} , θ )$$

where Mₐ(rᵢ) represents the probability of an azimuth streak occurring at range interval rᵢ. The azimuth streak probabilities across the range bins are then used to compute the final image using an adaptive gain mechanism. In other embodiments, instead of the target acoustic feature being azimuth-streaking, the target feature is another acoustic feature that is targeted for being specifically addressed through determining adaptive gain and individual splatting and image reconstruction (see steps 340-350). The method 300 continues to step 340.

In step 340, azimuth streak receiver gain data is determined based on the azimuth streak probability image of the step 330. In the present embodiment, an adaptive gain term, A, is introduced by the present embodiment in order to transform the azimuth streak probability image into receiver gains. The “azimuth streak receiver gain data” refers to data representing these receiver gains derived from azimuth streaking probabilities. In the present embodiment, a few observations are made. First, when no Gaussian in a range bin rᵢ has a high probability of azimuth streaking, the gain should be unity. Secondly, suppose a single Gaussian Gₖ exhibits a high probability of azimuth streaking across the range bin rᵢ. In that case, it is desirable to adaptively suppress the other Gaussians in rᵢ and assign a high gain to Gₖ. Finally, if multiple Gaussians in rᵢ have high probabilities of contributing to an azimuth streak, higher gain should be assigned to those Gaussians. To address these observations, the adaptive gain term is applied to each range-azimuth bin (rᵢ, θⱼ):

$$A ( {r}_{i} , {θ}_{j} ) = {P}_{a} ( {r}_{i} , {θ}_{j} ) {M}_{a} ( {r}_{i} ) \frac{{e}^{γ \cdot {P}_{a} ( {r}_{i} , {θ}_{j} )} + 1}{{e}^{γ} + 1} + ( 1 - {M}_{a} ( {r}_{i} ) )$$

where γ is a scaling factor that dictates the steepness of the adaptive gain. This behavior aligns with the insight presented in: if a certain percentage of returns exceeds a threshold, an operation is applied to all the values in a range interval. However, our proposed model differs because we do not restrict the gain to a fixed function (quadratic) but rather offer a family of curves for our splatting model to explore during optimization. The method 300 continues to step 350.

In step 350, an azimuth-streaked sonar image for the given pose is generated based on the azimuth streak receiver gain data and the initial (unsaturated) image. In at least the present embodiment, the final image with the azimuth streaks is then computed by applying the gain A(rᵢ, θⱼ) to its corresponding bin on I_{U}(rᵢ, θⱼ):

$$\hat{I} ( {r}_{i} , {θ}_{j} ) = A ( {r}_{i} , {θ}_{j} ) \cdot {I}_{U} ( {r}_{i} , {θ}_{j} )$$

resulting in the final rendered sonar image Î(rᵢ, θⱼ). Here, the azimuth-streaked sonar image is an example of an acoustically-realistic sonar image as the sonar image was augmented with learned, acoustic-specific information, rendering a more realistic sonar image. The method 300 then ends.

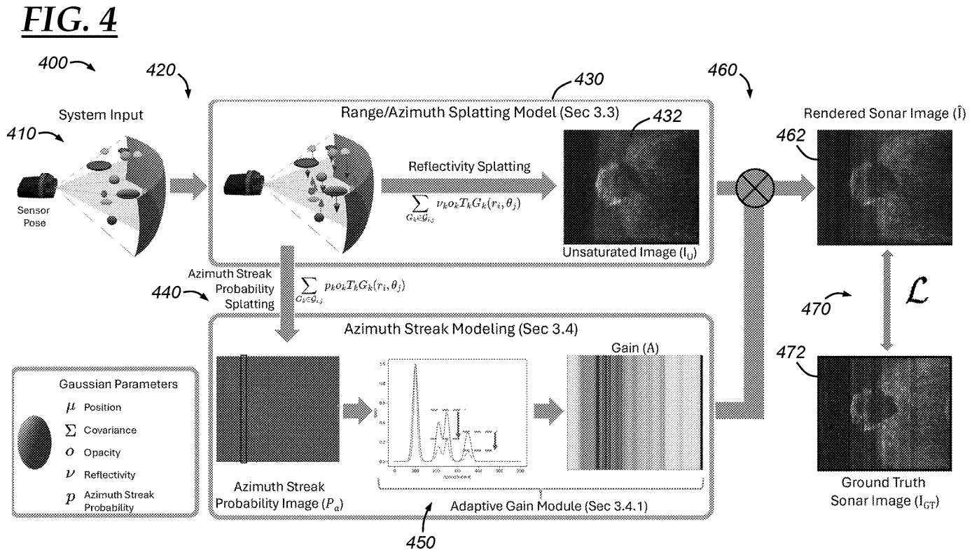

With reference to FIG. 4, there is shown an embodiment of a processing framework or method 400 for optimizing azimuth streaking probability (pₖ) of each Gaussian. In the present embodiment, the method 400 takes as input a sensor pose and an initial set of 3D Gaussians representing the scene, as shown at 410. Then, the 3D Gaussians are transformed into the sensor's image space, as shown at 420. Then, the reflectivity parameter vₖ is splatted (as shown at 430) to get the unsaturated image Iᵤ, as shown at 432. Step 430 may be performed using the method 200 and/or portions thereof, according to embodiments. Additionally, at step 440, per-Gaussian azimuth streaking probabilities pₖ are splatted. All the probabilities in range interval rᵢ are considered in the adaptive gain technique, as shown at 450, introduced herein and discussed above in connection with step 340, which is used for determining adaptive gain information (represented as the “azimuth streak gain data”) in order to adjust the receiver gain applied to Iᵤ. Finally, as shown at step 460, an azimuth-streak sonar image Î (at 462) by multiplying the gain A by Iᵤ. At least in the present embodiment, all parameters are optimized using gradient descent by taking losses with respect to the sonar image pixel values. Also, at least in the present embodiment, all sonar images shown are polar (range-azimuth) coordinates.

As shown at 470, loss optimization is performed in order to determine desired parameters using stochastic gradient descent (SGD) and by taking losses ( [symbol] ₗ₁, [symbol] ₛₛᵢₘ) between Î (synthesized azimuth-streaked sonar image 462) and the ground truth image I_{GT} (referred to as “ground truth sonar image” 472). To properly optimize for the azimuth streaking probabilities pₖ of each Gaussian, identification of where azimuth streaks occur is firstly determined by calculating the average intensity of the range interval rᵢ. Then, for the first Nₛ iterations, training is performed only on pixels in range bins that exceed a certain (predetermined) average intensity threshold τ. Notably, at least in the present embodiment, pₖ is not optimized during this first training interval or phase. Then, after Nₛ iterations, training is performed only on pixels less than the predetermined threshold τ. In the present embodiment, optimization is not performed for parameters μₖ, Σₖ, oₖ, or rₖ during this second training interval. This way, the Gaussians (or other CLBFs) are able to be initialized to fit the images before isolating and optimizing the azimuth streaking (or other acoustic) parameters.

In the present embodiment, each Gaussian (or CLBF) is encouraged to have either high or low opacity via an opacity loss [symbol] ₒ. This prevents a set of medium-opacity Gaussians (or CLBFs) from producing the same pixel intensity. Rather, the model is encouraged to use the reflectance parameter rₖ to represent low-intensity returns. The negative log-likelihood of two Laplacian distributions is used, as in

$${ℒ}_{o} ( x ) = \vert x \vert \vert 1 - x \vert$$

The final loss becomes:

$$ℒ = {λ}_{l 1} {ℒ}_{l 1} + {λ}_{ssim} {ℒ}_{ssim} + {λ}_{o} {ℒ}_{o}$$

where λₗ₁, λₛₛᵢₘ, and λₒ are the weights for the L1, SSIM, and opacity losses respectively.

Since the present embodiment learns probabilities of azimuth streaking for each Gaussian/CLBF, the adaptive gain is able to be undone in order to render images without azimuth streaks present and recover suppressed returns.

Accordingly, the technology set forth proposes a sonar-only CLBF splatting framework, including (more particularly) a sonar-only 3D Gaussian splatting framework, for novel view synthesis for imaging sonar in underwater applications. First, the sonar rendering equation is adapted for efficient range-azimuth splatting by evaluating 3D Gaussians or CLBFs. Then, azimuth streaking is modeled within the Gaussian splatting framework, allowing us to learn per-Gaussian azimuth streaking probabilities and produce high-quality de-streaked images. Experiments were performed on real-world data in test tank and river environments. In the novel view synthesis task, the present embodiment using 3D Gaussians to represent an underwater scene outperforms baselines by +2.5 decibels (dB) peak signal-to-noise-ratio (PSNR) and demonstrates superior qualitative results. It was also demonstrated that the present embodiment learns scene geometry, demonstrated by both quantitative and qualitative results. Future work will focus on leveraging such technology as set forth herein for sonar data synthesis by randomizing scene parameters including acoustic reflectance and azimuth streaking probability. This can yield more diverse datasets for training sonar-based scene understanding algorithms, which may be stored in memory 24 or provided to the client computer 18 of the client computer system 16 (FIG. 1).

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A method of generating a sonar image for a given pose through splatting continuous, localized radial basis functions, comprising:
obtaining a set of multi-dimensional continuous localized basis functions used to acoustically represent a scene; and
generating a range-azimuth sonar image of the scene for a given pose based on the set of multi-dimensional continuous localized basis functions.

2. The method of claim 1, wherein the range-azimuth sonar image of the scene for the given pose is generated through splatting each multi-dimensional continuous localized basis function of the set of multi-dimensional continuous localized basis functions.

3. The method of claim 2, wherein each multi-dimensional continuous localized basis function is a three-dimensional (3D) continuous localized basis function.

4. The method of claim 3, wherein each multi-dimensional continuous localized basis function is a 3D Gaussian.

5. The method of claim 1, wherein each multi-dimensional continuous localized basis function of the set of multi-dimensional continuous localized basis functions used to represent the scene is parameterized with one or more acoustic parameters.

6. The method of claim 5, wherein the one or more acoustic parameters includes acoustic reflectivity and/or azimuth streak probability.

7. A method of generating an azimuth-streaked sonar image representing a scene, comprising:
obtaining a set of multi-dimensional continuous localized basis functions used to represent a scene;
generating an initial sonar image based on rasterizing the scene into for a given pose;
determining an azimuth streak probability image based on the set of multi-dimensional continuous localized basis functions for the given pose;
determining azimuth streak receiver gain data based on the azimuth streak probability image; and
generating an azimuth-streaked sonar image for the given pose based on the azimuth streak receiver gain data and the initial sonar image.

8. The method of claim 7, wherein the azimuth-streaked sonar image is a range-azimuth sonar image that is generated through splatting each multi-dimensional continuous localized basis function of the set of multi-dimensional continuous localized basis functions.

9. The method of claim 8, wherein each multi-dimensional continuous localized basis function is a three-dimensional (3D) continuous localized basis function.

10. The method of claim 9, wherein each multi-dimensional continuous localized basis function is a 3D anisotropic Gaussian.

11. The method of claim 7, wherein each multi-dimensional continuous localized basis function of the set of multi-dimensional continuous localized basis functions used to represent the scene is parameterized with one or more acoustic parameters.

12. The method of claim 11, wherein the one or more acoustic parameters includes azimuth streak probability.

13. The method of claim 12, wherein the one or more acoustic parameters is a plurality of acoustic parameters including the azimuth streak probability and at least one other acoustic parameter.

14. The method of claim 13, wherein the at least one other acoustic parameter includes acoustic reflectivity.

15. The method of claim 12, wherein the rasterizing used for generating the initial sonar image is performed in accordance with an acoustic image formation model that includes at least one acoustic parameter.

16. The method of claim 15, wherein the at least one acoustic parameter includes a first acoustic parameter that is different than the one or more acoustic parameters such that a different set of acoustic parameters is used for parameterizing the set of multi-dimensional continuous localized basis functions than those used in the acoustic image formation model for rasterization.

17. A method of learning parameter values for a machine learning model, comprising obtaining training data having the azimuth-streaked sonar image as generated according to the method of claim 7, wherein the method comprises: performing machine learning for the machine learning model based on the azimuth-streaked sonar image for the given pose and a ground truth sonar image for the given pose.

18. The method of claim 17, wherein a plurality of azimuth-streaked sonar images are generated and each of the plurality of azimuth-streaked sonar images is paired with a corresponding ground truth sonar image based on correspondence in the given pose.

19. The method of claim 18, wherein the machine learning is performed for the machine learning model using a training process that includes, for each of the azimuth-streaked sonar images, updating one or more parameter values of the machine learning model based on a loss calculated between the azimuth-streaked sonar image and the corresponding ground truth sonar image.

20. A method of generating a sonar image for a given pose through splatting continuous, localized radial basis functions, comprising:
obtaining a set of multi-dimensional continuous localized basis functions used to represent a scene, wherein each multi-dimensional continuous localized basis functions of the set of multi-dimensional continuous localized basis functions is parameterized with a plurality of acoustic parameters including an acoustic target parameter;
generating an initial sonar image of the scene for a given pose based on splatting at least one acoustic parameter other than the acoustic target parameter according to the given pose;
generating an acoustic target parameterized image for the given pose based on splatting the acoustic target parameter of the set of multi-dimensional continuous localized basis functions according to the given pose; and
generating a sonar image for the given pose based on the initial sonar image for the given pose and the acoustic target parameterized image for the given pose.

21. A method of de-streaking a sonar image, comprising:
obtaining a set of multi-dimensional continuous localized basis functions used to represent a scene, wherein each multi-dimensional continuous localized basis functions of the set of multi-dimensional continuous localized basis functions is parameterized with at least one acoustic parameter;
obtaining training data having at least one training data entry comprised of an azimuth-streaked sonar image for a given pose and a ground truth sonar image for the given pose,
learning a set of azimuth-streak probability parameters for the using machine learning performed based on the training data;
obtaining a subject sonar image;
determining azimuth streak receiver gain data for the subject sonar image based on the learned set of azimuth-streak probability parameters; and
generating an azimuth-destreaked image based on the azimuth streak receiver gain data and the learned set of azimuth-streak probability parameters.

22. The method of claim 21, wherein the at least one acoustic parameter is azimuth streak probability.
